(19) United States
(12) Patent Application Publication
(10) Pub. No.: US 2025/0135669 A1
(43) Pub. Date: May 1, 2025

(54) SKIN CONTACT MEMBER FOR RAZOR CARTRIDGE

(71) Applicant: DORCO CO., LTD., Yongin-si (KR)

(72) Inventor: Se Min PARK, Seoul (KR)

(21) Appl. No.: 18/925,625

(22) Filed: Oct. 24, 2024

(30) Foreign Application Priority Data
Oct. 25, 2023 (KR) 10-2023-0143882

(51) Int. Cl. B26B 21/44; B26B 21/22; B26B 21/40

(52) U.S. Cl. CPC B26B 21/44; B26B 21/222; B26B 21/4018

(57) ABSTRACT

Proposed is a skin contact member for use in a razor cartridge having at least one blade received in a longitudinal direction. The skin contact member may include a head portion extending in the longitudinal direction to form a skin-contacting upper surface. The skin contact member may also include a body portion extending downward from the head portion in a height direction perpendicular to the longitudinal direction, the body portion to be inserted into a receiving space provided in the razor cartridge. The skin contact member may further include at least one opening portion formed in the head portion.

### CROSS-REFERENCE TO RELATED APPLICATION

This patent application claims priority to Korean Patent Application No. 10-2023-0143882, filed in Korea on Oct. 25, 2023, which is incorporated herein by reference in its entirety.

### BACKGROUND

### Technical Field

The present disclosure relates to a skin contact member for a razor cartridge.

### Description of Related Technology

When using a wet shaving razor, the friction between a blade housing and a user's skin, the cutting force applied to the hair to be shaved, and the irritation to wounded skin areas may cause discomfort to the user. To alleviate such discomfort, shaving aids such as shaving foam, shaving gel, and shaving cream may be used.

### SUMMARY

One aspect is a skin contact member for a razor cartridge, designed to effectively retain a shaving aid during shaving to continuously deliver the aid to the user's skin, thereby providing a smooth shaving experience.

The skin contact member for a razor cartridge according to an embodiment may easily discharge excessive shaving aid during shaving and residual shaving aid and cut hair during cleaning of the razor.

Aspects of the present disclosure are not limited to the aforementioned, and other aspects not mentioned may be clearly understood by those skilled in the art from the description below.

Another aspect is a skin contact member for use in a razor cartridge having at least one blade received in a longitudinal direction, the member comprising: a head portion extending in the longitudinal direction to form a skin-contacting upper surface; a body portion extending downward from the head portion in a height direction perpendicular to the longitudinal direction, the body portion to be inserted into a receiving space provided in the razor cartridge; and at least one opening portion formed in the head portion.

According to one embodiment, a skin contact member for a razor cartridge may appropriately contain a shaving aid during shaving to continuously provide the shaving aid to a user's skin, thereby providing a smooth shaving experience to the user.

According to one embodiment, the skin contact member for a razor cartridge has the effect of facilitating the easy discharge of excessive shaving aid during shaving and residual shaving aid and cut hair during cleaning of the razor.

### BRIEF DESCRIPTION OF THE DRAWINGS

FIGS. 1A is a perspective view of a razor cartridge according to an embodiment of the present disclosure.

FIG. 1B is a perspective view of a razor cartridge according to another embodiment of the present disclosure.

FIG. 2 is an exploded perspective view of a razor cartridge according to an embodiment of the present disclosure.

FIG. 3 is a perspective view of a skin contact member according to an embodiment of the present disclosure.

FIG. 4 is a front view and a partial plan view of a skin contact member according to an embodiment of the present disclosure.

FIG. 5 is a cross-sectional view taken along line V-V′ of FIG. 4.

FIG. 6 is a cross-sectional view taken along line VI-VI′ of FIG. 1, showing a coupling structure of a skin contact member and a housing of a razor cartridge according to the present disclosure.

FIG. 7 is a perspective view of a skin contact member according to another embodiment of the present disclosure.

FIG. 8 is a front view and a partial plan view of the skin contact member according to another embodiment of the present disclosure.

FIG. 9 is a cross-sectional view taken along line IX-IX′ of FIG. 8.

FIGS. 10 and 11 are views showing examples of grooves formed in the skin contact member according to the present disclosure.

### DETAILED DESCRIPTION

Shaving aids contain lubricating ingredients and are applied to the user's skin before or after shaving. This helps to reduce the irritation caused to the user's skin during shaving. However, when using a wet razor with a shaving aid like shaving foam, there is an issue where the shaving aid may be displaced from the applied area due to water or repeated strokes. In addition, if the razor cartridge is designed to contain the shaving aid, there are problems with excessive retention of the shaving aid or difficulty in thoroughly cleaning the razor. Therefore, there is a need for a structure that allows the shaving aid to be effectively retained without being excessive or insufficient during shaving, while also enabling the smooth discharge of the shaving aid and cut hair during cleaning.

Hereinafter, some embodiments of the present disclosure will be described in detail with reference to the accompanying drawings. It is to be noted that in giving reference numerals to components of each of the accompanying drawings, the same components will be denoted by the same reference numerals even though they are illustrated in different drawings. Further, in describing exemplary embodiments of the present invention, well-known functions or constructions will not be described in detail since they may unnecessarily obscure the understanding of the present invention.

Terms ‘first’, ‘second’, i), ii), a), b), and the like, will be used in describing components according to embodiments of the present disclosure. These terms are only for distinguishing the components from other components, and the nature, sequence, order, or the like of the components are not limited by the terms.

When a configuration is described as being “connected,” “coupled,” or “plugged in” to another configuration, it should be understood that the configuration may be directly connected or plugged in to that other configuration, but that there may also be other configurations “connected,” “coupled,” or “plugged in” between each configuration.

Throughout the present specification, unless explicitly described to the contrary, “including” or “comprising” any components will be understood to imply the inclusion of other elements rather than the exclusion of any other elements.

The terms “. . . unit,” “module,” and the like in the specification refer to a unit that implements at least one function or operation, which may be implemented in hardware or software or a combination of hardware and software.

It is understood that the description of one embodiment may be applied to other embodiments, unless the contrary is indicated.

The following description of the present application, with accompanying drawings, is intended to describe exemplary embodiments of the present application and is not intended to represent the only embodiments in which the present application may be practiced.

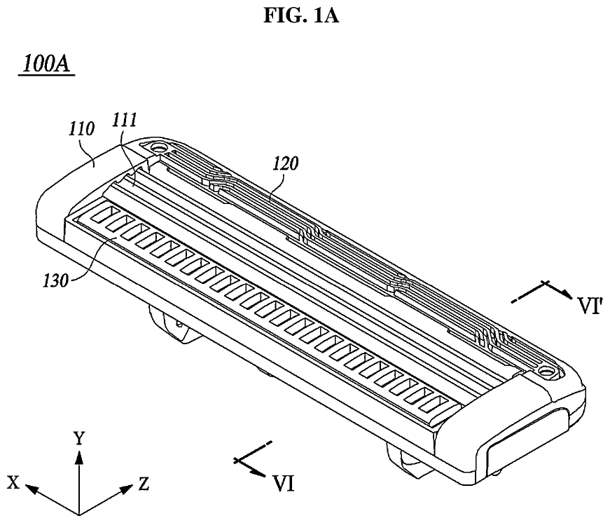

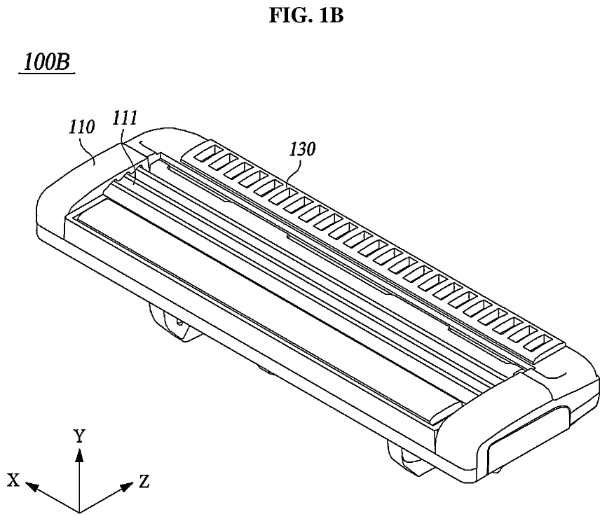

In addition, a longitudinal direction, height direction, and width direction used in this specification refer to an extension direction of the skin contact member, a height direction of the skin contact member, and a width direction of the skin contact member, respectively. For example, an X-axis direction, Y-axis direction, and Z-axis direction shown in FIG. 1A indicate the longitudinal direction, the height direction, and the width direction, respectively.

FIGS. 1A is a perspective view of a razor cartridge according to an embodiment of the present disclosure.

FIG. 1B is an exploded perspective view of a razor cartridge according to an embodiment of the present disclosure.

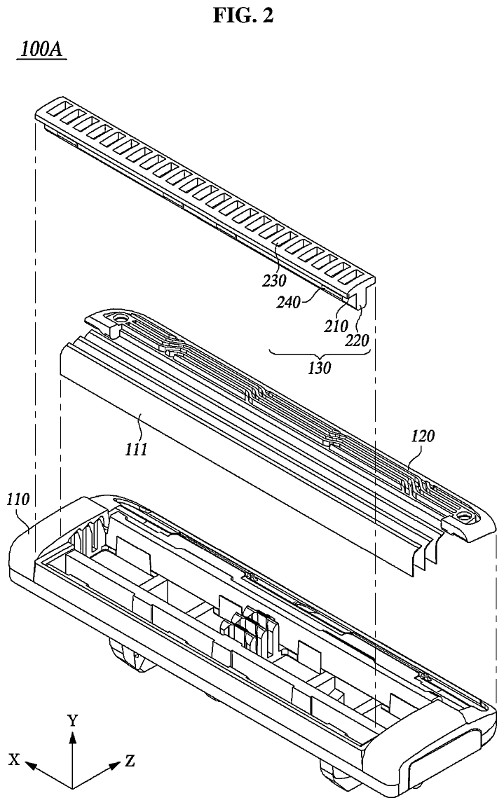

Referring to FIG. 1A and FIG. 2, a razor cartridge 100A according to an embodiment of the present disclosure may include a housing 110, a guard 120, and a skin contact member 130. The razor cartridge 100A may receive at least one blade 111 in a longitudinal direction.

The housing 110 may receive one or more blades 111 each having a cutting edge, the guard 120, and/or the skin contact member 130. That is, the housing 110 may include a receiving space into which the skin contact member 130 is inserted.

The guard 120 may be disposed in front of the blades 111. Specifically, the guard 120 may be disposed at an upper surface of the housing 110 toward which the cutting edges of the blades 111 are directed. The guard 120 may stretch a user's skin before cutting the body hair by the blades 111 during shaving. Accordingly, the user's body hair may stand in a direction approximately perpendicular to the user's skin surface, facilitating hair cutting by the blades 111. The guard 120 may include an elastic member to effectively stretch the skin. The guard 120 may be in contact with the user's skin during shaving, and may define a shaving plane together with the skin contact member 130.

The skin contact member 130 may be configured to be used in the razor cartridge 100A. A portion of the skin contact member 130 may be inserted and mounted into the receiving space of the razor cartridge 100A. As described above, the skin contact member 130 defines the shaving plane together with the guard 120 and is brought into contact with the user's skin during shaving. The skin contact member 130 may include an opening in at least a portion of it. During shaving, a shaving aid, such as a shaving foam pre-applied to the user's skin, may be introduced into the opening of the skin contact member 130 by a stroke action, so the shaving aid may be retained within the opening, thereby providing a smooth shaving experience to the user. In addition, since the opening is included, the skin contact member 130 may have a structure that allows an excessive amount of the shaving aid and cut body hair to be easily discharged during shaving or during cleaning of the razor cartridge 100A.

FIG. 1B is a perspective view of a razor cartridge according to another embodiment of the present disclosure. Specifically, FIG. 1B is a diagram illustrating an example in which the skin contact member 130 according to an embodiment of the present disclosure is disposed in front of a foremost blade 111 among the plurality of blades 111.

Referring to FIGS. 1A and 1B together, the skin contact member 130 may extend in the longitudinal direction. In addition, although FIG. 1a shows the skin contact member 130 disposed behind a rearmost blade 111 among the plurality of blades 111, the position of the skin contact member 130 is not limited to this example, and the skin contact member 130 may be disposed between the blades 111 or in front of the foremost blade 111, as shown in FIG. 1b. When the skin contact member 130 is disposed between the plurality of blades 111, the receiving space for the skin contact member 130 may also be formed between the plurality of blades 111. Furthermore, the skin contact member 130 may be provided in plural to be disposed in front of the foremost blade 111 and behind the rearmost blade 111. In other words, a plurality of skin contact members 130 may be provided, and the plurality of skin contact members 130 may be configured to be disposed in front of the foremost blade 111, behind the rearmost blade 111, and/or between the plurality of blades 111. The skin contact member 130 may be formed of a rigid material (e.g., plastic) to ensure a long service life.

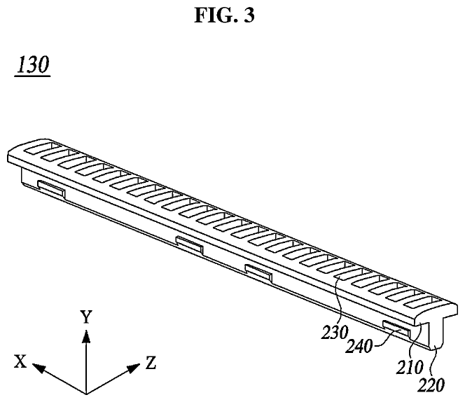

FIG. 3 is a perspective view of a skin contact member according to an embodiment of the present disclosure.

Referring to FIG. 3, the skin contact member 130 may include a head portion 210, a body portion 220, an opening portion 230, and a protrusion portion 240. At least a portion of the top of the head portion 210 of the skin contact member 130 may extend in the longitudinal and width directions to form a skin-contacting upper surface, and the skin-contacting upper surface and an upper surface of a guard (not shown) may define a shaving plane together during shaving. The head portion 210 may extend in the longitudinal direction and be relatively short in the width direction. At least a portion of the head portion 210 may be inserted into the receiving space of the housing 110.

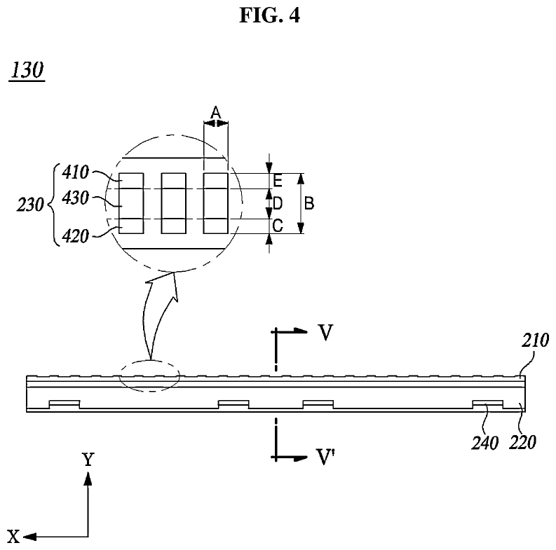

FIG. 4 is a front view and a partial plan view of a skin contact member according to an embodiment of the present disclosure.

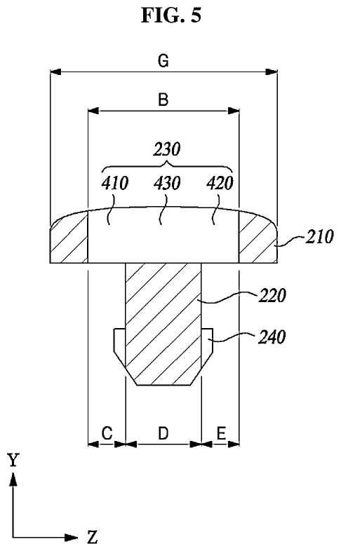

FIG. 5 is a cross-sectional view taken along line V-V′ of FIG. 4.

Referring to FIGS. 4 and 5, an opening portion 230 may include a first opening 410, a second opening 420, and a recess 430.

At least a portion of the head portion 210 may have the opening portion 230 formed therein. Specifically, the first opening 410, the second opening 420, and/or the recess 430 may be formed in the head portion 210. The head portion 210 may be formed integrally with a body portion 220, which will be described later. The first opening 410, the second opening 420, and/or the recess 430 may be arranged in a line in a width direction.

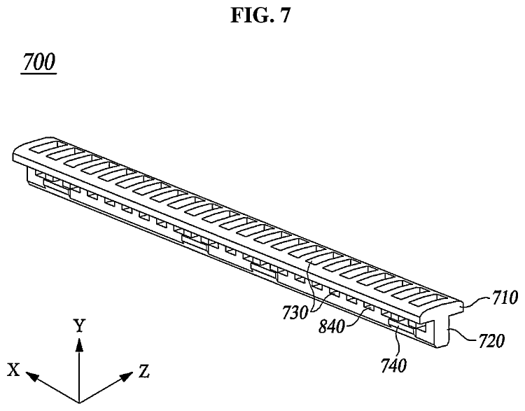

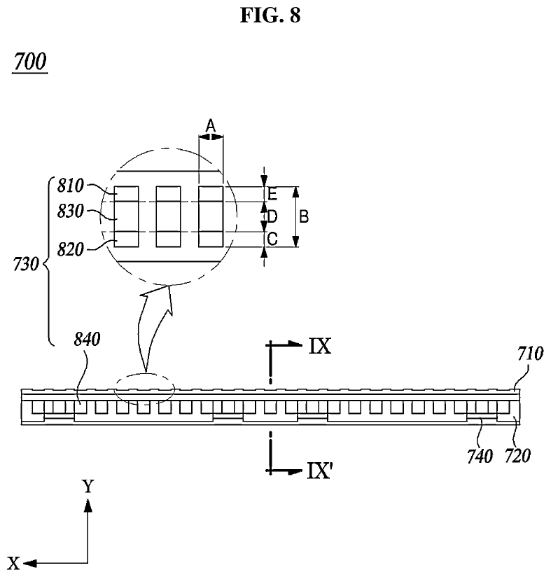

The opening portion 230 of the skin contact member 130 according to an embodiment of the present disclosure may be formed in the head portion 210. As shown in FIG. 4, when viewed in a direction parallel to a height direction from the head portion 210 toward the body portion 220, the opening portion 230 may include the first opening 410 formed at one side of the head portion 210 in the width direction, the second opening 420 formed at the other side of the head portion 210 in the width direction, and the recess 430 formed to overlap with the body portion 220 between the first opening 410 and the second opening 420. The recess 430 may be formed in the head portion 210 in a direction toward the body portion 220 from a skin-contacting upper surface. However, the opening portion 230 does not necessarily have to include all of the first opening 410, the second opening 420, and the recess 430, but may include all or part thereof. For example, the opening portion 230 may include the first opening 410 and the recess 430 or may include the second opening 420 and the recess 430. Meanwhile, according to another embodiment of the present disclosure, the opening portion (see 730 in FIGS. 7 and 840 in FIG. 8) may also be formed in a body portion 720.

The recess 430 may contain a shaving aid during shaving for continuous supply of the shaving aid to a user's skin, thereby providing a smooth shaving experience. The first opening 410 and the second opening 420 allow excessive shaving aid to be discharged during shaving, or allow the shaving aid and cut hair to be smoothly discharged during cleaning of the razor cartridge 100A, 100B. In addition, the first opening 410 and the second opening 420 may serve to contain shaving aid in a form of foam. In the height direction, the first opening 410 and the second opening 420 have an open structure in a height direction, while the recess 430 may have an open structure only in a direction toward the skin-contacting upper surface.

Referring back to FIG. 4, a sum of a widthwise length E (e.g., 0.5 mm) of the first opening 410 and a widthwise length C (e.g., 0.5) of the second opening 420 may be equal to or less than a widthwise length D (e.g., 1.0 mm) of the recess 430. As described above, the recess 430 primarily serves to contain the shaving aid, the first opening 410 and the second opening 420 primarily serve to discharge the shaving aid and cut hairs, and the sum of the widthwise length E of the first opening 410 and the widthwise length C of the second opening 420 is equal to or less than the widthwise length D of the recess 430. Consequently, it is possible to discharge excessive shaving aid during shaving and discharge hairs and the shaving aid during cleaning of the razor cartridge while ensuring that an appropriate amount of the shaving aid is retained in the skin contact member 130. This ensures that the shaving aid is continuously supplied to the user's skin during shaving.

Meanwhile, even when the opening portion 230 includes either the first opening 410 or the second opening 420 and the recess 430, the same effect may be achieved if the widthwise length E or C of either the first opening 410 or the second opening 420 is smaller than the widthwise length D of the recess 430.

Referring back to FIG. 5, the first opening 410, the second opening 420, and the recess 430 may be formed to be in fluid communication with one another. That is, the first opening 410, the second opening 420, and the recess 430 may all be connected. Therefore, both containing and discharging shaving aids may be effectively performed.

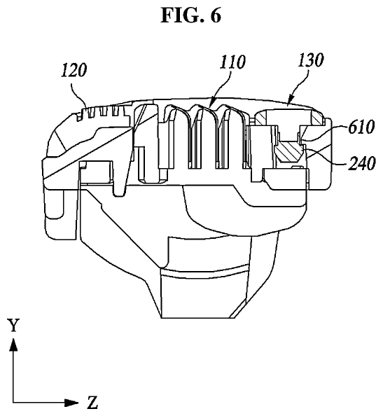

FIG. 6 is a cross-sectional view taken along line VI-VI′ of FIG. 1, showing a coupling structure of a skin contact member and a housing of a razor cartridge according to the present disclosure.

Referring to FIG. 6, a body portion 220 extends downward from a head portion 210 in a height direction, which is perpendicular to longitudinal and width directions, and is configured to be inserted into a receiving space of the razor cartridge 100A, 100B. By inserting the body portion 220 into the receiving space, a skin contact member 130 may be mounted to the housing 110. For example, as shown in FIG. 6, a protrusion portion 240 may be formed in the body portion 220 to protrude outward from a side surface, and when the body portion 220 may be inserted into a receiving space of the razor cartridge 100A, 100B, the skin contact member 130 may be mounted to the housing 110 in a snap-fit manner where the protrusion portion 240 is inserted into a latching portion 610 provided in the receiving space. According to one embodiment of the present disclosure, no opening is formed at the body portion 220; however, according to another embodiment (see FIGS. 7 to 9), an opening (e.g., the side opening 840 in FIG. 8) may also be formed in the body portion (see body portion 720 in FIG. 7). Details about the opening formed in the body portion 720 will be described later with reference to FIGS. 7 to 9. The body portion 220 may be integrally formed with the head portion 210.

FIG. 7 is a perspective view of a skin contact member 700 according to another embodiment of the present disclosure.

FIG. 8 is a front view and a partial plan view of a skin contact member 700 according to another embodiment of the present disclosure.

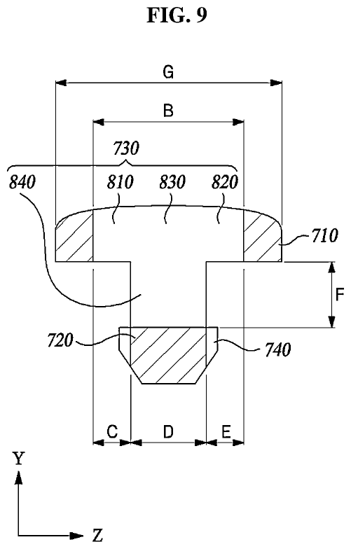

FIG. 9 is a cross-sectional view taken along line IX-IX′ of FIG. 8.

With reference to FIGS. 7 to 9, the skin contact member 700 according to another embodiment of the present disclosure will be described in detail. Meanwhile, the contents described above concerning one embodiment of the present disclosure may be equally or similarly applied to the other embodiments to the extent that the contents are not against the other embodiments.

An opening portion 730 of the skin contact member 700 according to another embodiment of the present disclosure may further include a side opening 840 extending downward in a height direction from a recess 830 and formed in a side surface of the body portion 720. That is, according to another embodiment of the present disclosure, the opening portion 730 may be formed not only in a head portion 710 but also in the body portion 720.

As the opening portion 730 of the skin contact member 700 further includes the side opening 840, excessively retained shaving aid in the skin contact member 700 may be discharged through the side opening 840. In addition, a used shaving aid retained by the skin contact member 700 may be smoothly discharged to an outside through the side opening 840, and a new shaving aid may be supplied to the skin contact member 700 from the outside, enabling hygienic and effective shaving with a fresh supply of shaving aid.

Meanwhile, in order to ensure that the skin contact member 700 retains a sufficient amount of the shaving aid for continuous supply of the shaving aid to a user's skin, the side opening 840 may have an appropriate height to prevent excessive discharge of the shaving aid. For example, a heightwise length F (e.g., 0.9 mm) of the side opening 840 may be equal to or less than one-third of a widthwise length G (e.g., 3.0 mm) of the head portion 710, as shown in FIG. 9.

Meanwhile, the opening portion 230, 730 of the skin contact member 130, 700 according to the present disclosure may include all or some of the first opening 410, 810, the second opening 420, 820, the recess 430, 830, and the side opening 840. For example, the opening portion 230, 730 may include only the first opening 410, 810 and the recess 430, 830 formed at one side of the head portion 210, 710, or may include only the recess 430, 830 and the side opening 840, or may include all of the first opening 410, 810, the second opening 420, 820, the recess 430, 830, and the side opening 840.

As a specific example, the opening portion 730 may include only the recess 830 and the side opening 840. In this case, the opening portion 730 may be formed in both the head portion 710 and the body portion 720. The recess 830 may be formed in the head portion 710 in a direction from a skin-contacting upper surface toward the body portion 720. The side opening 840 may extend downward in a height direction from the recess 830 and be formed in a side surface of the body portion 720. The recess 830 may be formed to overlap with the body portion 720 in a direction from the head portion 710 toward the body portion 720.

In this specification, the skin contact member 130, 700 has been described in one embodiment without the side opening 840, and in another embodiment with the side opening 840 included. However, the present disclosure should not be limited to the descriptions provided in this specification. It should be understood that the present disclosure includes embodiments where the skin contact members 130, 700 include all or part of the first opening 410, 810, the second opening 420, 820, the recess 430, 830, and the side opening 840.

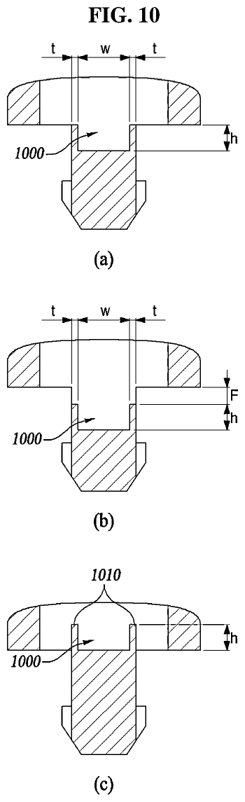

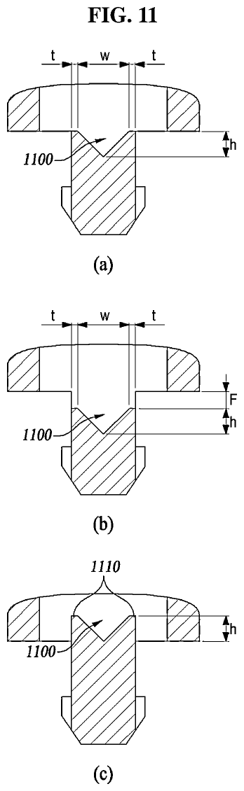

FIGS. 10 and 11 are views showing examples of grooves formed in the skin contact member according to the present disclosure.

Referring to FIGS. 10 and 11, a groove 1000, 1100 may be formed in a body portion 220, 720 of a skin contact member 130, 700 according to the present disclosure. The groove 1000, 1100 may be formed at one side (upper surface) of the body portion 220, 720 in the height direction.

As shown in (a) and (c) of FIG. 10 and (a) and (c) of FIG. 11, in a case where a side opening 840 (see FIG. 8) is not formed, the groove 1000, 1100 may be considered formed in the skin contact member 130 according to one embodiment of the present disclosure. As shown in (b) of FIG. 10 and (b) of FIG. 11, in a case where the side opening 840 (see FIG. 8) with a height F is formed, the groove 1000, 1100 may be considered formed in the skin contact member 700 according to another embodiment of the present disclosure. Hereinafter, the groove 1000, 1100 formed in the skin contact member 130, 700 will be described based on theses embodiments.

As shown in (a) of FIG. 10 and (a) of FIG. 11, the groove 1000, 1100 may be formed at one side of the body portion 220 and 720 in the height direction, where at least a portion of a side upper end of the body portion 220 may be positioned at a height equal to that of a lower end of the head portions 210 in a height direction. In this case, the groove 1000, 1100 may be in a shape where the recess 430 (see FIG. 4) extends downward toward the body portion 220 along the height direction.

Referring to (b) of FIG. 10 and (b) of FIG. 11, the groove 1000, 1100 may be formed at one side of the body portion 720 in the height direction, and at least a portion of a side upper end of the body portions 720 may be positioned below a lower end of the head portion 710. In this case, the opening portion 730 formed in the skin contact member 700 may include a side opening 840 (see FIG. 8), and the groove 1000, 1100 may be in a shape extending downward through the side opening 840 from the recess 830 along the height direction.

As shown in (c) of FIG. 10 and (c) of FIG. 11, the groove 1000, 1100 may be formed by a side wall 1010, 1110 extending upward from one side of the body portion 220, 720 in the height direction and placed in the recess 430. In this case, the groove 1000, 1100 may overlap with at least a portion of the recess 430.

As shown in FIGS. 10 and 11, a cross-sectional shape of the groove 1000, 1100 may, but not limited to, include open-ended rectangles and “V” shapes, and may include various shapes such as “U” shapes.

A length of a groove in a height direction (height, h) may be equal to or less than a length of the groove in a width direction (width, w). When the groove 1000, 1100 is formed by the side wall 1010, 1110 disposed in the recess 430, the height h of the side wall 1010, 1110 may refer to a height h of the groove 1000, 1100, and in this case, the height h of the side wall 1010, 1110 may be equal to or less than a width w of the groove 1000, 1100. For example, the height h (e.g., 0.4 mm or less) of the groove 1000, 1100 may be equal to or less than half the width w (e.g., 0.8 mm). In a case where both the side opening 840 and the groove 1000, 1100 are included (see (b) of FIG. 10 and (b) of FIG. 11), a length F (e.g., 0.3 mm) in the height direction from the lower end of the head portion 710 to the side upper end of the body portion 720, that is, the height F of the side opening 840, may be formed shorter than the height h (e.g., 0.4 mm) of the groove 1000, 1100, as viewed in a cross-section cut along the width direction. Consequently, it is possible to prevent excessive discharge of shaving aid through the side opening 840 while retaining the shaving aid in the groove 1000, 1100.

In this manner, the groove 1000, 1100 is formed at one side of the body portion 220 and 720, thereby enhancing the retention of shaving aid. Moreover, as the groove 1000, 1100 is formed with a depth that is not excessively deep, such as the height h of the groove being equal to or less than the width w of the groove, it is possible to prevent contamination of the skin contact member 130, 700 due to unnecessary shaving aid and body hairs remaining in the grooves without being discharged.

Referring back to FIGS. 3, 7, and 8, according to the present disclosure, the opening portion 230 and 730 including the first opening 410, 810, the second opening 420, 820, the recess 430, 830, and/or the side openings 840 may be in plural, and a plurality of opening portions 230, 730 may be arranged in a longitudinal direction. The plurality of opening portions 230, 730 may be spaced apart in the longitudinal direction. In this case, the plurality of opening portions 230, 730 may be spaced apart at equal intervals from each other, but aspects of the present disclosure are not limited to this arrangement. The intervals between the plurality of opening portions 230, 730 may vary, as needed.

Among the plurality of opening portions 230, 730 spaced apart in the longitudinal direction, some opening portions 730 may include the side openings 840 and other opening portions 230 may not include the side openings 840. Accordingly, both containing and discharging shaving aids may be effectively performed. The opening portions 730 including the side openings 840 and the opening portions 230 not including the side openings 840 may be alternately arranged.

Thus, the skin contact member 130 and 700 according to the present disclosure may include the plurality of opening portions 230, 730 arranged in the longitudinal direction, and at least some of the plurality of opening portions 230, 730 include the side openings 840, enabling effective performance of both containing and discharging of shaving aid.

The spirit of the present embodiment is illustratively described hereinabove. It will be appreciated by those skilled in the art to which the present embodiment pertains that various modifications and alterations may be made without departing from the essential characteristics of the present embodiment. Accordingly, the present embodiments are not to limit the spirit of the present embodiment, but are to describe the spirit of the present embodiment. The technical idea of the present embodiment is not limited to these embodiments. The scope of the present embodiment should be interpreted by the following claims, and it should be interpreted that all the spirits equivalent to the following claims fall within the scope of the present embodiment.

What is claimed is:

1. A skin contact member for use in a razor cartridge comprising at least one blade received in a longitudinal direction, the skin contact member comprising:
a head portion extending in the longitudinal direction to form a skin-contacting upper surface;
a body portion extending downward from the head portion in a height direction perpendicular to the longitudinal direction, the body portion configured to be inserted into a receiving space provided in the razor cartridge; and
at least one opening portion formed in the head portion.

2. The skin contact member of claim 1, wherein, as viewed in a direction parallel to the height direction from the head portion toward the body portion, the at least one opening portion each comprises:
a first opening formed at one side of the head portion in a width direction perpendicular to the longitudinal direction and the height direction,
a second opening formed at the other side of the head portion in the width direction, and
a recess formed to overlap with the body portion between the first opening and the second opening.

3. The skin contact member of claim 2, wherein in the width direction, a sum of a length of the first opening and a length of the second opening is equal to or less than a length of the recess.

4. The skin contact member of claim 2, wherein the first opening, the second opening, and the recess are in fluid communication with one another.

5. The skin contact member of claim 2,
wherein the at least one opening portion is formed in the head portion and the body portion, and
wherein the skin contact member further comprises a side opening extending downward in the height direction from the recess and formed in a side surface of the body portion.

6. The skin contact member of claim 5, wherein a length of the side opening in the height direction is equal to or less than one-third of a length of the head portion in the width direction.

7. The skin contact member of claim 2, wherein a groove is formed at one side of the body portion in the height direction, as viewed in a cross-section cut along the width direction.

8. The skin contact member of claim 7, wherein a length of the groove along the height direction is equal to or less than the length of the groove along the width direction.

9. The skin contact member of claim 7, wherein a side wall forming the groove is disposed in the recess, as viewed in a cross-section cut along the width direction.

10. The skin contact member of claim 7, wherein, as viewed in a cross-section cut along the width direction, at least a portion of a side upper end of the body portion is positioned at a height equal to a height of a lower end of the head portion in the height direction.

11. The skin contact member of claim 7, wherein, as viewed in a cross-section cut along the width direction, at least a portion of a side upper end of the body portion is positioned lower than a lower end of the head portion in the height direction.

12. The skin contact member of claim 11, wherein, as viewed in the cross-section cut along the width direction, a length in the height direction from the lower end of the head portion to the side upper end of the body portion is less than a length of the groove in the height direction.

13. The skin contact member of claim 2,
wherein the at least one opening portion comprises a plurality of opening portions spaced apart from each other in the longitudinal direction.

14. The skin contact member of claim 13, wherein the plurality of opening portions are spaced apart from each other at equal intervals.

15. The skin contact member of claim 13, wherein at least some of the plurality of opening portions comprise side openings extending downward from the recess in the height direction, as viewed in a cross section cut along a width direction perpendicular to the longitudinal direction and the height direction.

16. The skin contact member of claim 15, wherein some opening portions including the side openings and other opening portions among the plurality of opening portions are alternately arranged in the longitudinal direction.

17. The skin contact member of claim 1, wherein the skin contact member comprises a rigid material.

18. The skin contact member of claim 1,
wherein the opening is formed in the head portion and the body portion, and
wherein the skin contact member comprises a recess formed in the head portion in a direction from the skin-contacting upper surface toward the body portion, and a side opening extending downward from the recess in the height direction and formed in a side surface of the body portion, and
wherein the recess overlaps the body portion in a direction from the head portion to the body portion.
